(19) United States
(12) Patent Application Publication
(10) Pub. No.: US 2026/0032636 A1
(43) Pub. Date: Jan. 29, 2026

(54) APPARATUS AND METHOD FOR PROVIDING POSITIONING SERVICE

(71) Applicant: ELECTRONICS AND TELECOMMUNICATIONS RESEARCH INSTITUTE, Daejeon (KR)

(72) Inventors: JaeJun Yoo, Daejeon (KR); Junhaeng LEE, Daejeon (KR); JiWoo Han, Daejeon (KR)

(21) Appl. No.: 19/232,263

(22) Filed: Jun. 9, 2025

(30) Foreign Application Priority Data
Jul. 23, 2024 (KR) 10-2024-0097072

(51) Int. Cl. H04W 64/00; H04B 17/318; H04W 84/12

(52) U.S. Cl. CPC H04W 64/006; H04B 17/328; H04W 84/12

(57) ABSTRACT

Disclosed is an apparatus for providing a service, which includes a communication module, a positioning database (DB) configured to store a plurality of information about positioning resources observable at each of a plurality of reference points within a target area, and a processor functionally connected to the communication module and the positioning DB, wherein the processor is configured to acquire surrounding positioning resource information and movement state information of a mobile terminal through the communication module, select several points within a predicted location range of the mobile terminal from the plurality of reference points based on previous location information and the movement state information of the mobile terminal, and determine a location with a highest similarity to the acquired positioning resource information among the several points as a current location of the mobile terminal.

### CROSS-REFERENCE TO RELATED APPLICATION

This application claims priority to and the benefit of Korean Patent Application No. 10-2024-0097072, filed on Jul. 24, 2024, the disclosure of which is incorporated herein by reference in its entirety.

### BACKGROUND

### 1. Field of the Invention

Various embodiments disclosed in this document relate to technology for determining a location of a mobile terminal.

### 2. Description of Related Art

Recently, as indoor spaces have become larger, many activities are conducted indoors, and mobile terminals such as smartphones have become essential for modern people. Accordingly, the demand for determining the location of mobile terminals in the indoors has also been increasing.

Unlike outdoor areas in which satellite-based positioning is possible through global navigation satellite system (GNSS) signal reception, the location of mobile terminals in GNSS signal shadow areas or indoor spaces may be estimated through other positioning methods based on wireless signals (wireless fidelity (WiFi), Long-Term Evolution (LTE), or Bluetooth Low Energy (BLE)) and sensor signals (geomagnetic sensors or images) of mobile terminals. As a representative example, the fingerprint technique is used to build a positioning database for wireless signals and sensor signals received in indoor spaces in advance. Subsequently, an electronic device determines the location of a mobile device by performing similarity search between information scanned by the mobile terminal and the positioning DB. And electronic device selects the location with the highest similarity as the location of the mobile terminal.

### SUMMARY OF THE INVENTION

Recently, various location-based services for mobile terminals have been spread. To this end, the location of the mobile terminal needs to be continuously determined. In fingerprint-based methods, an electronic device repeatedly and continuously performs positioning resource acquisition from a mobile terminal and similarity search in a pre-constructed positioning DB. In this case, the electronic device repeatedly performs similarity search in the entire positioning DB based on the positioning resources collected by the mobile terminal. However, repeatedly similarity search in the entire positioning DB requires a significant amount of processing time and processing cost.

Various embodiments disclosed in this document may provide an apparatus and method for providing a positioning service, which allow similarity search processing between positioning resources for positioning computation to be improved.

According to an aspect of an embodiment, there is provided an apparatus for providing a service, which includes a communication module, a positioning database (DB) configured to store a plurality of information about positioning resources observable at each of a plurality of reference points within a target area, and a processor functionally connected to the communication module and the positioning DB, wherein the processor is configured to acquire surrounding positioning resource information and movement state information of a mobile terminal through the communication module, select several points corresponding to a predicted location range of the mobile terminal from the plurality of reference points based on previous location information and the movement state information of the mobile terminal, and determine a location with a highest similarity to the acquired positioning resource information among the several points as a current location of the mobile terminal.

According to an aspect of an embodiment, there is provided a mobile terminal including a communication module, a sensor module related to detecting movement of the mobile terminal, a memory in which instructions related to a designated application are stored, and a processor functionally connected to the sensor module, the communication module, and the memory, wherein, while the designated application is executed, the processor is configured to generate surrounding positioning resource information based on signals of surrounding positioning resources through the communication module, and generate movement state information of the mobile terminal through the sensor module, and acquire previous location information of the mobile terminal from the memory, and select several points corresponding to a predicted location range of the mobile terminal from a plurality of reference points in a positioning database (DB) based on the previous location information and the movement state information, wherein the positioning DB is a DB in an external service providing apparatus that stores a plurality of information about the positioning resources observable at each of the plurality of reference points in a target area, and determine a location with a highest similarity to the acquired positioning resource information among the several points as a current location of the mobile terminal.

According to an aspect of an embodiment, there is provided a method of providing a positioning service, which is performed by at least one processor, which includes acquiring surrounding positioning resource information and movement state information of a mobile terminal, selecting several reference points within a predicted location range of the mobile terminal from a plurality of reference points in a positioning database (DB) based on previous location information and the movement state information of the mobile terminal, wherein the positioning DB stores a plurality of information about positioning resources observable at each of the plurality of reference points within a target area, and determining a location with a highest similarity to the acquired positioning resource information among the several points as a current location of the mobile terminal.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram for describing a method of accelerating a similarity search between an inverted index data structure-based positioning database (DB) and a current location according to an embodiment;

FIG. 2 is a conceptual diagram of terminal location determination according to an embodiment;

FIG. 3 is a block diagram of a mobile terminal according to an embodiment;

FIG. 4 is a block diagram of an apparatus for providing a service according to an embodiment;

FIG. 5 is a flowchart of a positioning service method according to an embodiment; and

FIG. 6 is an exemplary diagram of a positioning service according to an embodiment.

In association with the description of the drawings, identical or similar reference numerals may be used for identical or similar components.

### DETAILED DESCRIPTION OF EXEMPLARY EMBODIMENTS

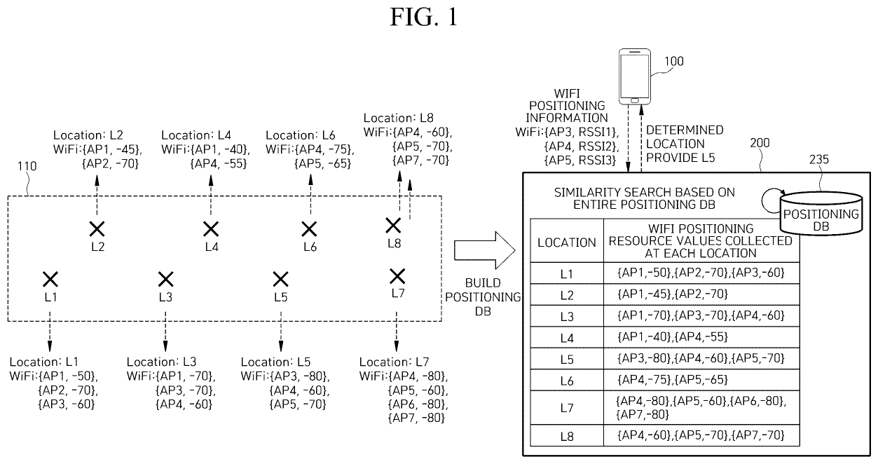

FIG. 1 is a diagram for describing a method for accelerating a similarity search between an inverted index data structure-based positioning database (DB) and a current location according to an embodiment. In FIG. 1, a case in which a positioning resource is a wireless fidelity access point (WiFi AP) is described as an example. However, it is not limited thereto. For example, the positioning resource may include various positioning resources such as Bluetooth Low Energy (BLE), Long-Term Evolution (LTE), etc.

Referring to FIG. 1, an apparatus 200 for providing a service according to an embodiment may check received signal strength indication (RSSI) information based on received signals from WiFi APs at first to eighth locations L1 to L8 of a global navigation satellite system (GNSS) shadow area (target area) 110. In an embodiment, the apparatus 200 for providing a service may be a computing system of a positioning service provider. The first to eighth locations L1 to L8 may be, for example, locations (points) in which signals for each AP (one of AP1 to AP7) are observed, and may be designated in advance by the service provider.

According to an embodiment, the apparatus 200 for providing a service may build a first positioning DB 150 that stores positioning resource information collected at each location (one of L1 to L8) based on each location (one of L1 to L8) (see column 1 of the positioning DB 235). The positioning resource information may include, for example, positioning resource identification information and reception sensitivity information. For example, the apparatus 200 for providing a service may check access points APs (AP1 to AP7) observable at each location (one of L1 to L8) and RSSI values of the APs in the GNSS shadow area. The apparatus 200 for providing a service may store identification information (e.g., ID) and the RSSI values of each AP in association in association with each other in the positioning DB 235. For example, the apparatus 200 for providing a service may store, in association with information on the first location L1 in the positioning DB 235, positioning resource information observable at the first location L1 in association with (e.g., {AP1, −50}, {AP2, −70}, and {AP3 −60}).

Thereafter, as a user terminal 100 (e.g., a mobile terminal of a positioning service user) scans surrounding positioning resources, the positioning resource scan result may be transmitted. When the apparatus 200 for providing a service acquires the positioning resource scan result, the apparatus 200 for providing a service may perform a similarity search on the positioning resource scan result and the entire first positioning DB 150. The apparatus 200 for providing a service may provide a location with the most similar positioning resource as the current location of the user terminal 100 based on the similarity search result. For example, the apparatus 200 for providing a service may check positioning resource information {AP3, RSSI1}, {AP4, RSSI2}, and {AP5, RSSI3} from the positioning resource scan result and determine a candidate location of the mobile terminal 100 as L5 through a similarity search between the checked positioning resource information and the positioning DB 235.

However, in order to determine the location for an actual GNSS shadow area, the number of locations for constructing the positioning DB 235 (e.g., L1 to L8 in FIG. 1) or pieces of AP information collected at each location may increase to tens to hundreds or more. Therefore, even a single location determination of a mobile terminal 100 may require similarity search with hundreds of thousands to millions of locations in the positioning DB 235. The larger the amount of data in the positioning DB 235, the longer the search processing time becomes, and the greater the probability of errors in location calculation.

However, according to an embodiment, a similarity search for location determination of a mobile terminal based on a fingerprint positioning DB may be improved. This will be described below.

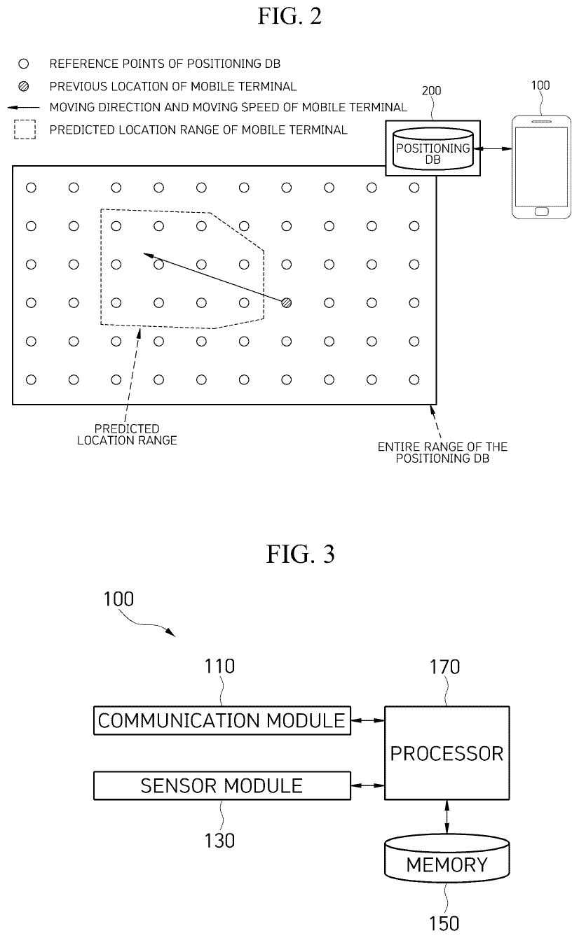

FIG. 2 is a conceptual diagram of terminal location determination according to an embodiment.

Referring to FIGS. 1 and 2, the positioning DB 235 according to the embodiment may store a plurality of information about positioning resources associated with a plurality of reference points (“O” parts of FIG. 2) within a target area. Each of the reference points may be stored in association with, for example, all positioning resource information (e.g., fingerprint) related to location determination within the target area that may be observed from the reference points. For example, when the target area is a road, the reference points may include nodes and links. For another example, when the target area is an indoor space, the reference points may include points obtained by dividing the indoor space into a grid at regular intervals.

According to an embodiment, the mobile terminal 100 may be a terminal on which a designated application for a location determination service is installed. The mobile terminal 100 may be at least one wireless communication-capable terminal among a portable terminal, a smart phone, a smart pad, a notebook, and a laptop. Alternatively, the mobile terminal 100 may be at least one mobile terminal among a vehicle device, a robot, and a drone.

According to an embodiment, the mobile terminal 100 may transmit and receive data with the apparatus 200 for providing a service to determine the location of the mobile terminal 100 while the designated application is running. The transmitted and received data may include, for example, surrounding positioning resource information of the mobile terminal 100, movement state information of the mobile terminal 100, and determined location information (e.g., previous location information, current location information).

In an embodiment, the mobile terminal 100 may check reception sensitivity of the surrounding positioning resource that provide the wireless channel, generate positioning resource information including the checked reception sensitivity, and transmit the positioning resource information to the apparatus 200 for providing a service. The positioning resource information may be, for example, surrounding positioning resource information (e.g., information related to a wireless communication channel) currently observed by the mobile terminal 100.

In an embodiment, the mobile terminal 100 includes a GPS sensor, an acceleration sensor, and a gyro sensor, and may generate movement state information related to the movement of the mobile terminal 100 using the sensors and transmit the movement state information to the apparatus 200 for providing a service. The movement state information may be, for example, information related to the movement direction, movement speed, and acceleration of the mobile terminal.

According to an embodiment, the apparatus 200 for providing a service may acquire positioning request-related data including surrounding positioning resource information, previous location information, and movement state information from the mobile terminal 100. The positioning request-related data may further include at least one of time information and reliability information related to previous location information.

According to an embodiment, when the apparatus 200 for providing a service acquires the positioning request related data, the apparatus 200 for providing a service may limit a similarity search range in the positioning DB 235 using some of the data. For example, the apparatus 200 for providing a service may select several points corresponding to a predicted location of the mobile terminal 100 among all reference points in the positioning DB 235 based on the previous location information (e.g., see the black circle in FIG. 2) and the movement state information of the mobile terminal 100. For another example, the apparatus 200 for providing a service may determine the predicted location range of the mobile terminal 100 by predicting the degree to which the mobile terminal 100 has moved from the previous location information based on information about a movement direction, a movement speed, and an acceleration. For another example, the apparatus 200 for providing a service may check information on time at which the previous location information has been determined and determine the predicted location range of the mobile terminal 100 further based on the time information.

In an embodiment, the apparatus 200 for providing a service may determine a predicted location range including predicted locations of the mobile terminal 100 and several points around the predicted location (see points belonging to the dotted polygon in FIG. 2). For example, the apparatus 200 for providing a service may predict a moved location based on a moving direction, moving speed, and acceleration from a previous location of the mobile terminal 100 and determine a predicted location range to include reference points at a specified distance in the predicted location. The specified distance may be set to be, for example, less than the distance between the reference points. Additionally or alternatively, the specified distance may be experimentally determined to correspond to a location determination error.

According to an embodiment, the apparatus 200 for providing a service may check several points within the predicted location range and pre-registered positioning resource information related to the several points. The apparatus 200 for providing a service may determine the current location of the mobile terminal 100 within the target area based on the similarity between the pre-registered positioning resource information and the acquired positioning resource information. For example, the apparatus 200 for providing a service may determine a point corresponding to positioning resource with the highest similarity to the acquired positioning resource information among pieces of positioning resource information related to the several points in the positioning DB 235 as the current location of the mobile terminal 100. When there are a plurality of points corresponding to the positioning resource with the highest similarity, the apparatus 200 for providing a service may determine the middle point of the plurality of points as the current location of the mobile terminal 100.

According to an embodiment, when the apparatus 200 for providing a service determines the current location of the mobile terminal 100, the apparatus 200 for providing a service may provide the determined current location information to the mobile terminal 100. For example, the apparatus 200 for providing a service may provide the current location of the mobile terminal 100 to the mobile terminal 100 in association with the information on time at which the movement state information of the mobile terminal 100 has been acquired. Additionally, the apparatus 200 for providing a service may store the current location information of the mobile terminal 100 in the positioning DB 235.

According to an embodiment, the apparatus 200 for providing a service may provide current location information of the mobile terminal 100, time information, and reliability information together to the mobile terminal 100. The time information may be, for example, information on time at which the current location information has been determined. The reliability information may be, for example, a prediction error of the current location information. Alternatively, the reliability information may be determined based on an error between the current location information and subsequent location information determined based on positioning resource information acquired later, upon acquiring surrounding positioning resource information of the mobile terminal 100 after provision of the current location information. In this document, a case in which the reliability information is a prediction error is illustrated.

According to various embodiments, the apparatus 200 for providing a service may check the reliability of the previous location information and selectively use the previous location information according to the checked reliability. For example, the apparatus 200 for providing a service may determine the predicted location range of the mobile terminal 100 using only the previous location information of which the reliability exceeds a specified criterion in the previous location information. The specified criterion may be set such that, for example, the location determination error of the mobile terminal 100 is within a specified distance.

According to various embodiments, the apparatus 200 for providing a service may further limit the predicted location range based on other state information of the mobile terminal 100. For example, the mobile terminal 100 may further transmit terminal type information (e.g., a vehicle, a drone, and a smartphone) as positioning request related data. In this case, the apparatus 200 for providing a service may select a predicted location range from the positioning DB 235 excluding points that are not accessible by the mobile terminal 100 according to type, based on the terminal type information.

In this way, the apparatus 200 for providing a service according to an embodiment may reduce the range of similarity search for determining the location of the mobile terminal 100 in the positioning DB 235 and improve the processing speed positioning DB using not only the surrounding positioning resources of the mobile terminal 100 but also the movement state information of the mobile terminal 100 when determining the location of the mobile terminal 100 using fingerprint data.

In addition, the apparatus 200 for providing a service according to an embodiment may improve the location determination speed of the mobile terminal 100 by reducing the range of similarity search for the positioning DB 235, and improve the computational accuracy by reducing amount of computation.

Furthermore, the apparatus 200 for providing a service according to an embodiment may improve the usability and satisfaction of various location-based applications and services of the mobile terminal 100 by improving the real-time performance and accuracy of the positioning service.

FIG. 3 is a block diagram of a mobile terminal according to an embodiment.

Referring to FIG. 3, a mobile terminal 100 mobile terminal 100 according to an embodiment may include a sensor module 130, a communication module 110, a memory 150, and a processor 170. In an embodiment, in the mobile terminal 100, some components may be omitted or additional components may be added. In addition, some of the components of the mobile terminal 100 may be combined to form a single component, but may perform the same functions of the components before the combination.

The sensor module 130 may output signals related to the location, posture, and acceleration of the mobile terminal 100. The sensor module 130 may include a GPS sensor, an acceleration sensor, and a gyro sensor.

The communication module 110 may support the establishment of a communication channel or a wireless communication channel between the mobile terminal 100 and another device (e.g., an apparatus 200 for providing a service), and the performance of communication through the established communication channel. The communication channel may include, for example, at least one of local area network (LAN), fiber to the home (FTTH), a digital subscriber line (xDSL), wireless broadband (WiBro), Wireless LAN, WiFi, Bluetooth, Zigbee, WFD (Wi-Fi Direct), UWB (Ultrawideband), infrared data association (IrDA), Bluetooth Low Energy (BLE), near field communication (NFC), 3G, 4G, or 5G. The communication module 110 may communicate using known communication methods such as code division multiple access (CDMA), Global System for Mobile Communications (GSM), W-CDMA, time division-synchronous code division multiple access (TD-SCDMA), WiBro, Long Term Evolution (LTE), and Evolved Packet Core (EPC), etc.

The memory 150 may include various types of volatile memories or nonvolatile memories. For example, the memory 150 may include a read only memory (ROM) and a random access memory (RAM). In an embodiment, the memory 150 may be located inside or outside the processor 170, and the memory 150 may be connected to the processor 170 through various known means. The memory 150 may store various types of data used by at least one component (e.g., the processor 170 of the apparatus 200 for providing a service. The data may include, for example, input data or output data for software and instructions related thereto. For example, the memory 150 may store at least one instruction and data for providing a location determination service. The memory 150 may include a positioning DB 235. The positioning DB 235 may store a plurality of reference point information of a target area and a plurality of information about positioning resources observable at each of the reference points.

The processor 170 may control at least one other component (e.g., hardware or software component) of the apparatus 200 for providing a service and may perform various data processing processes or calculations. The processor 170 may include, for example, at least one of a central processing unit (CPU), a graphics processing unit (GPU), a microprocessor, an application processor, an application specific integrated circuit (ASIC), and a field programmable gate array (FPGA), and may have a plurality of cores.

According to an embodiment, the processor 170 may transmit and receive data to and from the apparatus 200 for providing a service through the communication module 110 to determine the location of the mobile terminal 100 while the designated application is running. The transmitted and received data may include, for example, surrounding positioning resource information of the mobile terminal 100, movement state information, and determined location information (e.g., previous location information and current location information). The designated application may include, for example, a dedicated application for a terminal location determination service or an application for a general navigation service. In an embodiment, the processor 170 may provide a positioning service according to a command of the designated application. However, since the main agent of the designated application is the processor 170, the processor 170 is described as the main agent in this document.

According to an embodiment, the processor 170 may generate movement state information related to the movement of the mobile terminal 100 using the sensor module 130. The movement state information may include, for example, information on a movement direction, a movement speed, and an acceleration of the mobile terminal.

According to an embodiment, the processor 170 may generate positioning resource information based on the reception sensitivity of the surrounding positioning resource through the communication module 110. The positioning resource information may be, for example, surrounding positioning resource information (e.g., information related to a wireless communication channel) currently observed by the mobile terminal 100. The positioning resource information may include the reception sensitivity of various positioning resources, such as a WiFi access point, BLE, and LTE. In this document, a case in which the positioning resource information is an RSSI value of a WiFi AP is described as an example.

According to an embodiment, the processor 170 may transmit surrounding positioning resource information and movement state information to the apparatus 200 for providing a service, for positioning of the mobile terminal 100. The processor 170 may retrieve previous location information of the mobile terminal 100 and time information and reliability information related to the previous location information that are stored in the memory 150, and further transmit the previous location-related data including the previous location information, the time information, and the reliability information to the apparatus 200 for providing a service.

According to an embodiment, the processor 170 may select several points belonging to a predicted location range of the mobile terminal 100 from a plurality of reference points in the positioning DB 235 based on the previous location information and the movement state information using the positioning DB 235 of the apparatus 200 for providing a service. For example, the processor 170 may determine a predicted location range of the mobile terminal 100 by predicting a movement state of the mobile terminal 100 from previous location information based on information about a movement direction, a movement speed, and an acceleration. For another example, the processor 170 may identify (detect or determine) time information related to previous location information, and further based on the time information, select a predicted location range by calculating a distance moved from the previous location with the current moving speed and direction for the time elapsed until the current time.

According to an embodiment, the processor 170 may check the reliability of the previous location information, and use only the previous location information, of which the reliability exceeds a specified criterion in the previous location information, for the positioning service. The specified criterion may be set such that the location determination error of the mobile terminal 100 is within a specified distance.

According to an embodiment, the processor 170 may select a predicted location range by further utilizing terminal type information (e.g., a vehicle, a drone, and a smartphone). In this case, the processor 170 may select a predicted location from the positioning DB 235 range excluding points that are not accessible by the mobile terminal 100 according to type, based on the terminal type information.

According to an embodiment, the processor 170 may check the similarity between (pre-registered) positioning resource information related to several points in the positioning DB 235 and acquired positioning resource information. The processor 170 may determine a point related to the positioning resource with the highest similarity to the acquired positioning resource information among pieces of pre-registered positioning resource information as the current location of the mobile terminal 100.

Thereafter, the processor 170 may provide various services (e.g., route guidance) based on the current location of the mobile terminal 100. In FIG. 3, a case in which the processor 170 proactively determines the location of the mobile terminal 100 using the positioning DB 235 in the apparatus 200 for providing a service is described as an example. However, the present disclosure is not limited thereto. The mobile terminal 100 may request the apparatus 200 for providing a service to calculate the current location of the mobile terminal 100. This will be described below.

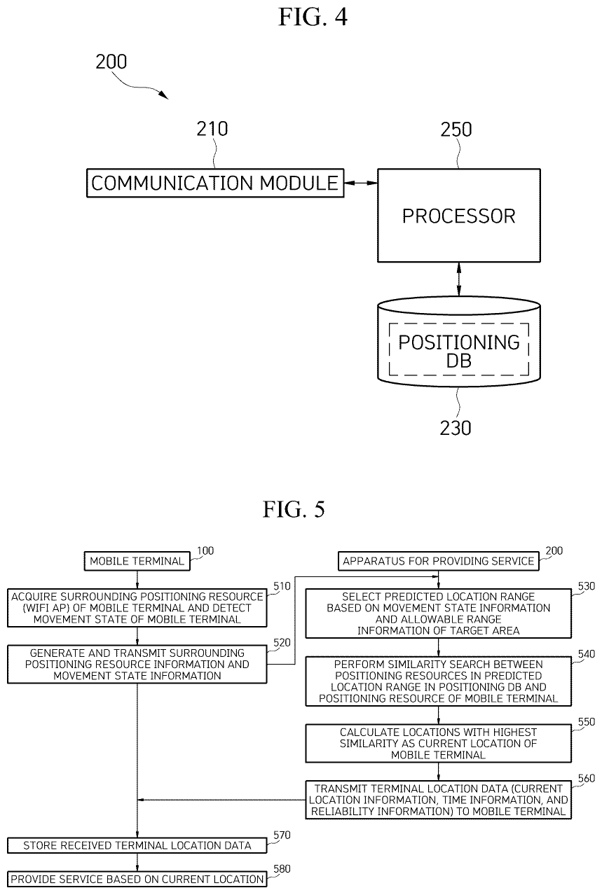

FIG. 4 is a block diagram of an apparatus for providing a service according to an embodiment.

Referring to FIG. 4, an apparatus 200 for providing a service according to an embodiment may include a communication module 210, a memory 230, and a processor 250. In an embodiment, in the apparatus 200 for providing a service, some components may be omitted or additional components may be added. In addition, some of the components of the apparatus 200 for providing a service may be combined to form a single component, but may perform the same functions of the components before the combination.

The communication module 210 may support the establishment of a communication channel or a wireless communication channel between the apparatus 200 for providing a service and another device (e.g., a mobile terminal 100), and the performance of communication through the established communication channel. The communication channel may include, for example, at least one of local area network (LAN), fiber to the home (FTTH), a digital subscriber line (xDSL), wireless broadband (WiBro), Wireless LAN, WiFi, Bluetooth, Zigbee, WFD (Wi-Fi Direct), UWB (Ultrawideband), infrared data association (IrDA), Bluetooth Low Energy (BLE), near field communication (NFC), 3G, 4G, or 5G. The communication module 210 may communicate using known communication methods such as code division multiple access (CDMA), Global System for Mobile Communications (GSM), W-CDMA, time division-synchronous code division multiple access (TD-SCDMA), WiBro, Long Term Evolution (LTE), and Evolved Packet Core (EPC), etc.

The memory 230 may include various types of volatile memories or nonvolatile memories. For example, the memory 230 may include a read only memory (ROM) and a random access memory (RAM). In an embodiment, the memory 230 may be located inside or outside the processor 250, and the memory 230 may be connected to the processor 250 through various known means. The memory 230 may store various types of data used by at least one component (e.g., the processor 250) of the apparatus 200 for providing a service. The data may include, for example, input data or output data for software and instructions related thereto. For example, the memory 230 may store at least one instruction and data for providing a positioning service. The memory 230 may include a positioning DB 235 that stores a plurality of information about positioning resources that are observable from each of a plurality of reference point information of a target area. The positioning DB 235 may include type-specific allowable criteria information related to reference points within the target area. The memory 230 may store information related to a specified distance and information related to specified criteria.

The processor 250 may control at least one other component (e.g., hardware or software component) of the apparatus 200 for providing a service and may perform various data processing processes or calculations. The processor 250 may include, for example, at least one of a central processing unit (CPU), a graphics processing unit (GPU), a microprocessor, an application processor, an application specific integrated circuit (ASIC), and a field programmable gate array (FPGA), and may have a plurality of cores.

According to an embodiment, the processor 250 may transmit and receive data to and from a designated application of the mobile terminal 100 through the communication module 210 to determine the current location of the mobile terminal 100 within a target area. The target area may be a GNSS shadow area (e.g., an indoor environment) in which it is difficult to determine the location based on GPS signals.

According to an embodiment, the processor 250 may acquire positioning request-related data including surrounding positioning resource information and movement state information from the mobile terminal 100 through the communication module 210. The positioning resource information may be, for example, surrounding positioning resource information (e.g., reception sensitivity information) currently observed by the mobile terminal 100. The movement state information may be, for example, information related to a movement direction, a movement speed, and an acceleration of the mobile terminal.

According to an embodiment, the processor 250 may further receive previous location information, time information (e.g., a determination time) and reliability information from the mobile terminal 100 as positioning request-related data. The time information may be, for example, information on time at which the previous location information has been determined. The reliability information may be, for example, a prediction error of the previous location information. Alternatively, the reliability information may be determined based on an error between subsequent location information, which is determined after providing the previous location information, and the previous location information.

According to an embodiment, the processor 250 may select several points corresponding to a predicted location of the mobile terminal 100 from all reference points in the positioning DB 235 based on the previous location information (e.g., see the black solid circle in FIG. 2) and the movement state information of the mobile terminal 100. For example, the processor 250 may select the predicted location range of the mobile terminal 100 by predicting a movement pattern of the mobile terminal 100 from the previous location information based on information about a movement direction, a movement speed, and an acceleration. For another example, the processor 170 may, further based on time information related to previous location information, select a predicted location range by calculating a distance moved from the previous location with the current moving speed and direction for the time elapsed until the current time. The processor 170 may select a predicted location range within a specified distance from the predicted location. The specified distance may be experimentally determined to correspond to a position determination error.

According to an embodiment, the processor 250 may further acquire other state information, such as terminal type information, from the mobile terminal 100. The terminal type information may include information indicating whether the mobile terminal 100 is a vehicle device, a robot, a drone, or a smartphone. The processor 250 may select a predicted location range from the positioning DB 235 excluding points that are not accessible by the mobile terminal 100 according to type, based on the terminal type information. In this case, the processor 250 may identify points that are not accessible by the mobile terminal 100 according to type, using type-specific allowance criteria information related to reference points in the target area from the positioning DB 235. The allowance criteria information may be, for example, information about an obstacle (e.g., a wall) that restricts movement between reference points. For example, the processor 250 may exclude points that are temporally unreachable from a previous location based on the allowance criteria information and the movement state information.

Additionally, the processor 250 may check the reliability of the previous location information and selectively use the previous location information for location determination based on the checked reliability. For example, the processor 250 may select the predicted location range of the mobile terminal 100 using only previous location information of which the reliability exceeds a specified criterion among pieces of previous location information.

According to an embodiment, the processor 250 may determine the current location of the mobile terminal 100 within the target area by similarity search between surrounding positioning resource information of the mobile terminal 100 and positioning resource information related to selected several points. For example, the processor 250 may determine a point corresponding to positioning resource with the highest similarity to the acquired positioning resource information among pieces of positioning resource information related to several selected points in the positioning DB 235 as the current location of the mobile terminal 100. When there are a plurality of points corresponding to the positioning resource with the highest similarity, the processor 250 may also determine the location between the plurality of points as the current location of the mobile terminal 100.

According to an embodiment, the processor 250 may generate terminal location data including current location information, time information, and reliability information of the determined mobile terminal 100. The processor 250 may provide the terminal location data to the mobile terminal 100 through the communication module 210.

According to various embodiments, the processor 250 may provide the terminal location data to another service terminal that provides a location-based service of the mobile terminal 100. In this case, the other service terminal may provide, for example, a service (e.g., advertisements for nearby infrastructure) based on the current location of the mobile terminal 100.

According to various embodiments, the processor 250 may store location-related information of the mobile terminal 100, including current location information and time information of the mobile terminal 100, in the positioning DB 235.

In this way, the apparatus 200 for providing a service according to an embodiment may reduce the range of similarity search for determining the location of the mobile terminal 100 in the positioning DB 235 and improve the processing speed positioning DB using not only the surrounding positioning resources of the mobile terminal 100 but also the movement state information of the mobile terminal 100 when determining the location of the mobile terminal 100 using fingerprint data.

In addition, the apparatus 200 for providing a service according to an embodiment may improve the location determination speed of the mobile terminal 100 by reducing the range of similarity search for the positioning DB 235, and improve the computational accuracy by reducing amount of computation.

Furthermore, the apparatus 200 for providing a service according to an embodiment may improve the usability and satisfaction of various location-based applications and services of the mobile terminal 100 by improving the real-time performance and accuracy of the positioning service.

FIG. 5 is a flowchart of a positioning service method according to an embodiment.

Referring to FIG. 5, in operation 510, the mobile terminal 100 may acquire a signal from a surrounding positioning resource through the communication module 210 and detect a movement state through the sensor module 130.

In operation 520, the mobile terminal 100 may generate surrounding positioning resource information and movement state information and transmit the surrounding positioning resource information and the movement state information to the apparatus 200 for providing a service. For example, the mobile terminal 100 may check a positioning resource identification number and a reception sensitivity based on a signal from a surrounding positioning resource and generate positioning resource information including the identification number and the reception sensitivity. In addition, the mobile terminal 100 may detect information about a moving direction, a moving speed, and acceleration through the sensor module 130 and generate movement state information including the detected moving direction, speed, and acceleration. The mobile terminal 100 may transmit the surrounding positioning resource information and the movement state information to the apparatus 200 for providing a service through the communication module 210.

In operation 530, the apparatus 200 for providing a service may acquire the movement state information and the positioning resource information from the mobile terminal 100, and select a predicted location range of the mobile terminal 100 from the entire range of the positioning DB 235 based on the movement state information. The apparatus 200 for providing a service may check allowable range information of a target area, and select a predicted location range to include only points that are reachable by the mobile terminal 100 based on the allowable range information.

In operation 540, the apparatus 200 for providing a service may perform a similarity search between positioning resources in the positioning DB 235 corresponding to the location of the predicted location range and the surrounding positioning resource of the mobile terminal.

In operation 550, the apparatus 200 for providing a service may calculate the location with the highest similarity to the surrounding positioning resource information of the mobile terminal 100 in the predicted location range as the current location of the mobile terminal 100 through the similarity search.

In operation 560, the apparatus 200 for providing a service may transmit positioning request data including the calculated current location information, calculation time information, and reliability information to the mobile terminal 100.

In operation 570, the mobile terminal 100 may store the received terminal location data in the memory 150. In operation 580, the mobile terminal 100 may provide a designated service (e.g., a route guidance service) based on the calculated current location. The mobile terminal 100 may provide the apparatus 200 for providing a service with the terminal location data stored in the memory 150 as previous location information included in subsequent positioning request-related data.

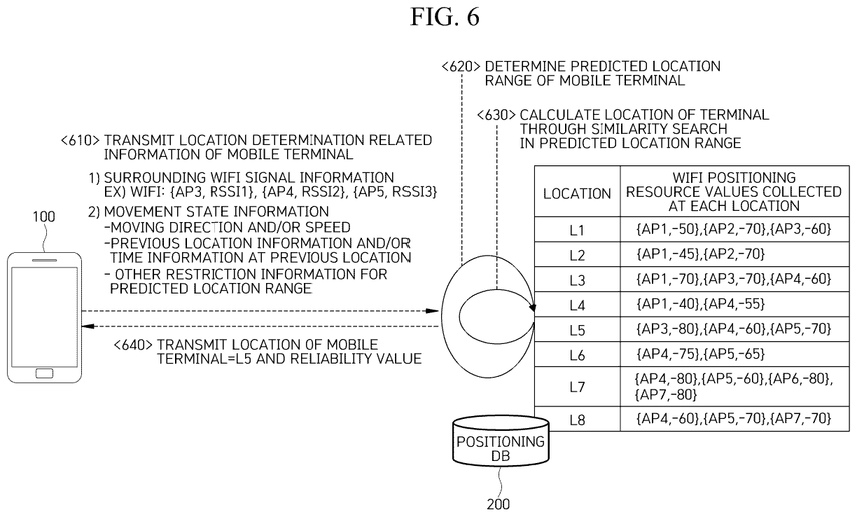

FIG. 6 is an exemplary diagram of a positioning service according to an embodiment.

Referring to FIG. 6, in operation 610, the mobile terminal 100 may generate positioning resource information including {AP3, RSSI1}, {AP4, RSSI2}, and {AP5, RSSI3} by checking the reception sensitivity values of RSSI1, RSSI2, and RSSI3 from surrounding positioning resources AP3, AP4, and AP5, respectively. In addition, the mobile terminal 100 may generate movement state information including information about a moving direction, a moving speed, previous location information, (calculation) time information of a previous location, and other predicted location restriction information. The mobile terminal 100 may transmit positioning request data including the surrounding positioning resource information and the movement state information.

In operation 620, the apparatus 200 for providing a service may select a predicted location range of the mobile terminal 100 from the entire range of the positioning DB 235 based on the movement state information. For example, the apparatus 200 for providing a service may select a predicted location range including locations L3 to L5 based on a previous location “L6,” a moving direction “a middle direction between L3 and L5,” previous time information, and a moving speed.

In operation 630, the apparatus 200 for providing a service may perform a similarity search between the positioning resource information related to the predicted location range and the surrounding positioning resource information of the mobile terminal 100 to calculate the location “L5” of the mobile terminal 100.

In operation 640, the apparatus 200 for providing a service may transmit the calculated current location “L5” of the mobile terminal 100, the calculation time information of the current location, and the reliability information of the previous location to the mobile terminal 100.

The various embodiments of the disclosure and terminology used herein are not intended to limit the technical features of the disclosure to the specific embodiments, but rather should be understood to cover all modifications, equivalents, and alternatives falling within the spirit and scope of the invention. Like numbers refer to like elements throughout the description of the drawings. The singular forms preceded by “a” and “an” corresponding to an item are intended to include the plural forms as well unless the context clearly indicates otherwise. In the disclosure, a phrase such as “A or B,” “at least one of A and B,” “at least one of A or B,” “A, B or C,” “at least one of A, B and C,” and “at least one of A, B, or C” may include any one of the items listed together in the corresponding phrase, or any possible combination thereof. Terms such as “first,” “second,” etc. are used to distinguish one element from another and do not modify the elements in other aspects (e.g., importance or sequence). When one (e.g., a first) element is referred to as being “coupled” or “connected” to another (e.g., a second) element with or without the term “functionally” or “communicatively,” it means that the one element is connected to the other element directly (e.g., by wire), wirelessly, or via a third element.

As used herein, the term “module” may include units implemented in hardware, software, or firmware, and may be interchangeably used with terms such as “logic,” “logic block,” “component,” or “circuit.” The module may be an integrally configured component or a minimum unit or part of the integrally configured component that performs one or more functions. For example, according to one embodiment, the module may be implemented in the form of an application-specific integrated circuit (ASIC).

The various embodiments of the present disclosure may be realized by software (e.g., a program) including one or more instructions stored in a storage medium (e.g., the memory 230 in FIG. 4) (e.g., an internal memory or external memory) that can be read by a machine (e.g., an electronic device). For example, a processor (e.g., the processor 250) of the machine (e.g., the apparatus 200 for providing a service) may invoke and execute at least one instruction among the stored one or more instructions from the storage medium. Accordingly, the machine operates to perform at least one function in accordance with the invoked at least one command. The one or more instructions may include code generated by a compiler or code executable by an interpreter. The machine-readable storage medium may be provided in the form of a non-transitory storage medium. Here, when a storage medium is referred to as “non-transitory,” it can be understood that the storage medium is tangible and does not include a signal (for example, electromagnetic waves), but rather that data is semi-permanently or temporarily stored in the storage medium.

According to one embodiment, the methods according to the various embodiments disclosed herein may be provided in a computer program product. The computer program product may be traded between a seller and a buyer as a product. The computer program product may be distributed in the form of a machine-readable storage medium (e.g., a compact disc read only memory (CD-ROM)) or may be distributed directly between two user devices (e.g., smartphones) through an application store (e.g., Play Store™), or online (e.g., downloaded or uploaded). In the case of online distribution, at least a portion of the computer program product may be stored at least semi-permanently or may be temporarily generated in a machine-readable storage medium, such as a memory of a server of a manufacturer, a server of an application store, or a relay server.

Components according to various embodiments of the disclosure may be implemented in the form of software or hardware, such as a digital signal processor (DSP), an FPGA or an ASIC, and may perform predetermined functions. The term “elements” is not limited to meaning software or hardware. Each of the elements may be configured to be stored in a storage medium capable of being addressed and configured to execute one or more processors. For example, the elements may include elements such as software elements, object-oriented software elements, class elements, and task elements, processes, functions, attributes, procedures, subroutines, segments of program code, drivers, firmware, microcode, circuits, data, databases, data structures, tables, arrays, and variables.

According to the various embodiments, each of the above-described elements (e.g., a module or a program) may include a singular entity or a plurality of entities. According to various embodiments, one or more of the above-described elements or operations may be omitted, or one or more other elements or operations may be added. Alternatively, or additionally, a plurality of elements (e.g., modules or programs) may be integrated into one element. In this case, the integrated element may perform one or more functions of each of the plurality of elements in a manner the same as or similar to that performed by the corresponding element of the plurality of components before the integration. According to various embodiments, operations performed by a module, program, or other elements may be executed sequentially, in parallel, repeatedly, or heuristically, or one or more of the operations may be executed in a different order, or omitted, or one or more other operations may be added.

According to various embodiments disclosed in this document, the similarity search processing between positioning resources for positioning calculation can be improved. In addition, various effects that may be directly or indirectly identified through this document may be provided.

What is claimed is:

1. An apparatus for providing a service, the apparatus comprising:
a communication module;
a positioning database (DB) configured to store a plurality of information about positioning resources observable at each of a plurality of reference points within a target area; and
a processor functionally connected to the communication module and the positioning DB,
wherein the processor is configured to:
acquire surrounding positioning resource information and movement state information of a mobile terminal through the communication module;
select several points within a predicted location range of the mobile terminal from the plurality of reference points based on previous location information and the movement state information of the mobile terminal; and
determine a location with a highest similarity to the acquired positioning resource information among the several points as a current location of the mobile terminal.

2. The apparatus of claim 1, wherein the movement state information includes information about a movement direction, a movement speed, and an acceleration.

3. The apparatus of claim 1, wherein the processor selects the predicted location range further based on information on time at which the previous location information has been determined.

4. The apparatus of claim 1, wherein the processor checks reliability of the previous location information and selectively uses the previous location information according to the checked reliability.

5. The apparatus of claim 1, wherein the processor is configured to:
acquire terminal type information from the mobile terminal;
check allowable criteria information of the target area from the positioning DB; and
select the several points belonging to the allowable criteria information according to the terminal type information,
wherein in case of that there are a plurality of locations with the highest similarity, the processor determines a middle point of the plurality of locations as the current location of the mobile terminal.

6. A mobile terminal comprising:
a communication module;
a sensor module related to detecting movement of the mobile terminal;
a memory in which instructions related to a designated application are stored; and
a processor functionally connected to the sensor module, the communication module, and the memory,
wherein, while the designated application is executed, the processor is configured to:
generate surrounding positioning resource information based on signals of surrounding positioning resources through the communication module, and generate movement state information of the mobile terminal through the sensor module;
acquire previous location information of the mobile terminal from the memory, and select several points within a predicted location range of the mobile terminal from a plurality of reference points in a positioning database (DB) based on the previous location information and the movement state information, wherein the positioning DB is a DB in an external electronic device that stores a plurality of information about the positioning resources observable at each of the plurality of reference points in a target area; and
determine a location with a highest similarity to the acquired positioning resource information among the several points as a current location of the mobile terminal.

7. The mobile terminal of claim 6, wherein the sensor module includes a global positioning system (GPS) sensor, an acceleration sensor and a gyro sensor, and the movement state information includes information about a movement direction, a movement speed, and an acceleration.

8. The mobile terminal of claim 6, wherein the processor selects the predicted location range further based on information on determination time of the previous location information.

9. The mobile terminal of claim 6, wherein the processor is configured to:
check reliability of the previous location information; and
selectively use the previous location information according to the checked reliability.

10. The mobile terminal of claim 6, wherein the processor is configured to:
check allowable criteria information of the target area from the positioning DB; and
select the several points belonging to the allowable criteria information according to terminal type information.

11. The mobile terminal of claim 6, wherein in case of that there are a plurality of locations with the highest similarity, the processor determines a middle point of the plurality of locations as the current location of the mobile terminal.

12. A method of providing a positioning service, which is performed by at least one processor, the method comprising:
acquiring surrounding positioning resource information and movement state information of a mobile terminal;
selecting several points within a predicted location range of the mobile terminal from a plurality of reference points in a positioning database (DB) based on previous location information and the movement state information of the mobile terminal, wherein the positioning DB stores a plurality of information about positioning resources observable at each of the plurality of reference points within a target area; and
determining a location with a highest similarity to the acquired positioning resource information among the several points as a current location of the mobile terminal.

13. The method of claim 12, wherein the selecting includes determining the predicted location range further based on information on time at which the previous location information has been determined.

14. The method of claim 12, wherein the selecting includes:
checking reliability of the previous location information; and
selecting the several points selectively using the previous location information according to the checked reliability.

15. The method of claim 12, wherein the selecting includes:
acquiring terminal type information from the mobile terminal;
checking allowable criteria information of the target area from the positioning DB; and
selecting the several points belonging to the allowable criteria information according to the terminal type information.
